(19) United States
(12) Patent Application Publication
(10) Pub. No.: US 2006/0241870 A1
(43) Pub. Date: Oct. 26, 2006

(54) Method for selection of optimal microarray probes

(75) Inventors: Michael Dahms, Biokenbach (DE); Andrea Schlauersbach, Aschaffenburg (DE); Michael Baum, Heidelberg-Kirchheim (DE)

Correspondence Address: ROTHWELL, FIGG, ERNST & MANBECK, P.C., 1425 K STREET, N.W., SUITE 800, WASHINGTON, DC, 20005, US

(73) Assignee: Febit AG, Mannheim (DE)

(21) Appl. No.: 10/554,720

(22) PCT Filed: May 7, 2004
(86) PCT No.: PCT/EP04/04913

§ 371 Date: Oct. 28, 2005

(30) Foreign Application Priority Data
May 8, 2003 (DE) 103 20 669.8
Oct. 31, 2003 (DE) 103 51 065.6

(51) Int. Cl. G06F 19/00

(52) U.S. Cl. 702/20

(57) ABSTRACT

The invention relates to a method for selecting a partial sequence from a nucleic acid sequence whose similarity to a given total sequence is as low as possible. More specifically, the invention relates to a method for selecting partial sequences of a given nucleic acid sequence, which are suitable for hybridization and, owing to their low similarity to said total sequence, can be used for detecting said given nucleic acid sequence.

The invention relates to a method for selecting a partial sequence from a nucleic acid sequence whose similarity to a given total sequence is as low as possible, apart from the included partial sequence itself. More specifically, the invention relates to a method for selecting partial sequences of a given nucleic acid sequence, which are suitable for hybridization and, owing to their low similarity to said total sequence, apart from the included partial sequence itself, can be used for detecting said given nucleic acid sequence.

In order to detect a particular fragment in a complex sample by hybridization by means of short oligonucleotides, the DNA sequence of said oligonucleotides must have many different properties. These oligonucleotide properties can be divided into two essential categories:

1. Oligonucleotide-intrinsic properties such as the tendency of forming secondary structures, stability of duplex compounds, base composition, etc.

2. Oligonucleotide specificity: information about the quality and correspondence of the second binding site of this oligonucleotide in the chosen database. An oligonucleotide is of no value to most applications, if it detects in addition to the DNA sequence actually to be detected also a multiplicity of other sequences. A signal from this oligonucleotide would not allow any conclusions about the detected sequence.

The importance of the oligonucleotide-intrinsic parameters with respect to the specificity varies, depending on the length of the oligonucleotides to be selected. Probes with relatively long chains (>50 bp) are very likely sufficiently specific for the fragment to be studied, but behave increasingly critically with respect to the formation of secondary structures and folds. Relatively short oligonucleotides (>30 bp) in turn have a lower tendency of forming folds. Here, however, ensuring the specificity of the selected oligonucleotides becomes more and more important.

In the case of oligonucleotides with relatively short chains, determination of the oligonucleotide-intrinsic parameters requires comparatively little calculation time. However, determination of the specificity of said oligonucleotides may require a lot of time, depending on the database used for testing.

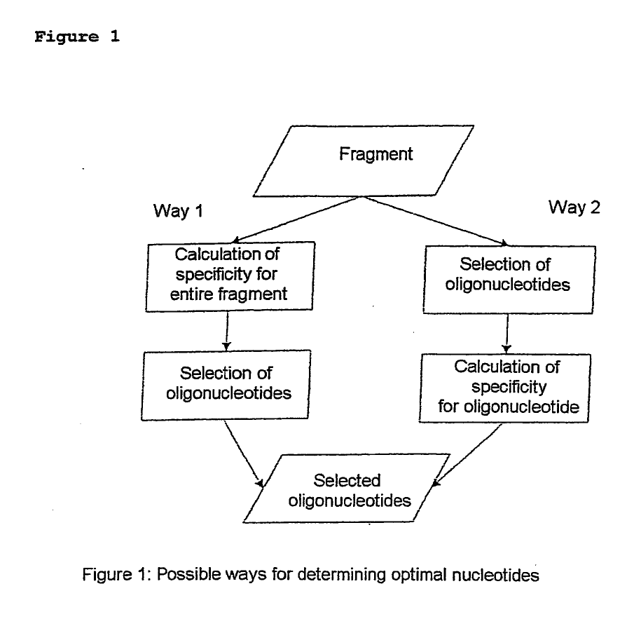

The procedure of calculating the specificity and selecting the oligonucleotides can generally be outlined in two ways which are depicted in FIG. 1. In the first way, the specificity for the entire fragment is calculated with respect to any nucleic acids which could occur in a predefined total sequence. In the second step, oligonucleotides suitable for hybridization and thus detection of said fragment are selected from the partial sequences specific for said fragment, on the basis of intrinsic properties. The second way pursues the reverse strategy. First, potential oligonucleotides are selected from the fragment on the basis of intrinsic properties and then, in the second step, tested for their specificity with respect to the nucleic acid sequences present in a predefined total sequence. Both ways offer specific advantages and disadvantages.

A method which utilizes way 1 has been published by the company Illumina (http://www.illumina.com/RefSet_Oligos Tech_Bulletin_{—}5-03.pdf). First, regions similar to a given transcript are identified in a set of nucleotide sequences, using ESTs (estimated sequence tags) from the GenBank database, for example. For this purpose, an alignment is carried out using the BLAST algorithm. On the basis of this, those sequences which, owing to their specificity, could be suitable as hybridization probes are selected from the given transcript. In the next step, the most suitable 70 mer is selected on the basis of fixed criteria. A fixed criterion is the melting point TM which must be at 78° C.±5° C. Another criterion is the self-complementarity of the sequence, which can result in the formation of hairpin structures. The stem sequence of said hairpin structure here is usually shorter than 10 bases. Yet another criterion is the distance to the 3′ end of the transcript, with sequences being given a negative value when located between 300 and 1000 nucleotides from the 3′ end. A sequence is excluded if the melting point is outside the range indicated, if the stem sequence which could form a hairpin structure is at least 10 bases in length or if the distance to the 3′ end of the transcript is 300 bases or less. In individual cases (0.1%), probes with stem sequences of 10 or more bases are permitted. The document does not reveal how a choice between alternative sequences all of which fulfill the given criteria is made. The method described has the disadvantage of requiring in particular virtually all of the specificity calculations to be repeated if the set of underlying nucleotide sequences needs to be extended. This applies in particular to ESTs which are usually incompletely annotated and are therefore subject to a continuous correction (addition/deletion) process. This disadvantage is particularly evident where a latest set of data is required as basis for probe calculation.

It is therefore the object of the present invention to provide methods which allow regions of a given fragment to be selected on the basis of the in each case most recent update of the publicly accessible nucleic acid databases, it being intended for the chosen regions to be as specific as possible for the fragment indicated and for the corresponding nucleic acids to be suitable for carrying out hybridizations. Advantageously, this object is achieved by carrying out the time-consuming calculation of specificities independently of the selection of selected regions/oligonucleotides and storing the results. Storing even specificity information about different lengths of said selected regions/oligonucleotides leads to maximum flexibility and performance in the subsequent selection of said oligonucleotides.

Methods which enable all process steps, from synthesis of the DNA on DNA chips via the biological experiment to data recording, to be carried out automatically in only a few hours are part of the prior art. Said methods may be carried out in a fully automated system. For example, the geniom® one from febit, Mannheim, Germany is an extraordinarily flexible device for the laboratory bench for synthesizing, hybridizing and detecting a large variety of oligonucleotides. It is therefore an object of the present invention to provide methods for selecting oligonucleotides, which can be processed so fast that the potential of automated systems such as, for example, geniom® one can be fully utilized.

These objects are achieved according to the invention by methods which are characterized by separating in time and space calculation of the specific regions and selection of optimal oligonucleotides by calculating specific regions in parallel using a plurality of computers and by evaluating the optimal oligonucleotides via an evaluation matrix which operates essentially without absolute exclusion criteria.

The aim of the inventive methods for calculating specific regions is to determine oligonucleotides which, if possible, occur only in one of a plurality/multiplicity of fragments, i.e. which unambiguously “code” for this fragment. Said oligonucleotides, referred to as probes, are applied, for example, in Gene Expression Profiling. Here, a probe is intended to code unambiguously for a particular gene so that it is possible to determine by hybridization, whether the corresponding gene has been expressed.

Prior to determining specific regions, other fragments must be defined in comparison with which the specificity of a particular fragment is to be calculated. One example of a possible objective is the comparison of all yeast genes with one another, in order to be able to determine unambiguous probes for all genes or particular groups of genes of this organism. The comparison of the selected fragments with one another is carried out in steps. For this purpose, each of the fragments is compared with each of the other selected fragments, avoiding, if possible duplicate comparisons.

Fragment refers to any type of genetic sequence and may be, for example, gene sequences, consensus sequences or unknown material. More specifically, the term fragment or else nucleic acid sequence, for example of the length m, is used in order to refer to the nucleic acid/nucleic acid sequence which is predefined and for which a specific partial sequence of the length n is to be selected. The term partial sequence is used only in this sense.

The total sequence is the entirety of all nucleotide sequences, for example in the form of a database, which is the basis for selection of the partial sequence. The total sequence includes, for example, the known sequences of nucleic acids which can occur in a sample, a tissue or an organism, for example a cell, with which a nucleic acid having the selected partial sequence is contacted. The total sequence may be, for example, the entire sequence of a genome such as the human genome. Alternatively, however, it may also be only a section of a genome such as, for example, the transcriptome. Other total sequences are also conceivable, for example a gene library or a mixture of clones.

Specificity and, respectively, calculation of specificity means, how often a partial sequence with a defined similarity appears within the total sequence. Selection relates to the choice of a nucleic acid on the basis of the physical and chemical properties and of the structure in comparison with other nucleic acids, i.e. the oligonucleotide-intrinsic properties. Selection relates, for example, to the selection of a partial sequence from at least two partial sequences.

The invention thus relates to a method for determining the similarity of a nucleic acid sequence with respect to a given total sequence, which method comprises the steps

(I) aligning said nucleic acid sequence with said total sequence, determining those contiguous parts of the total sequence, which correspond to a predetermined minimum degree to said sequence or to a partial sequence thereof, and

(II) describing said correspondence of said parts of the total sequence, determined in step (I), to said nucleic acid sequence or to a partial sequence thereof in the form of scores of at least one type for segments of at least a given length and

(III) where appropriate, merging the scores obtained in step (II).

This method may comprise further steps. In another embodiment, it is limited to the steps (I) to (III). In yet another embodiment, no minimum correspondence is defined for the alignment in step (I).

The invention further relates to a method for selecting a partial sequence of the length n from a nucleic acid sequence of the length m, whose similarity to a given total sequence which does not include said nucleic acid sequence of the length m should be as low as possible, said method comprising the steps

(a) generating a list of predetermined m-n+1 partial sequences, calculating for each partial sequence scores with respect to the total sequence by the above-described inventive method for determining the similarity of a nucleic acid sequence with respect to said total sequence, and

(b) selecting on the basis of said scores from said list according to step (a) those partial sequences whose similarity to the total sequence which does not include the nucleic acid sequence of the length m is a low as possible, and

(c) excluding those partial sequences of step (b) which do not fulfill the predetermined absolute criteria, and

(d) carrying out the method described below for selecting nucleic acid sequences from a list of nucleic acid sequences on the basis of a total score for each sequence with the partial sequences remaining after step (c).

This method may comprise further steps. In another embodiment, it is limited to steps (a) to (d). In yet another embodiment, no minimum correspondence is defined for the alignment.

In a preferred embodiment, the total sequence is the total sequence of a genome, for example of a mammal or of human origin, a section of a genome, for example the transcriptome, a gene library, for example a mixture of clones, a functional group of genes or/and a mixture of various genomes or/and of parts of various genomes or/and of genome sections.

The value of m may comprise the length of a plurality of genomes, in particular of mammalian genomes. Preferably, m comprises the lengths of up to five, more preferably of up to three, genomes and most preferably of up to one complete genome. The value for the lower limit of m may comprise the length of at least one gene or one segment of a gene. Preferably, it comprises the length of at least 100 genes or segments of genes, more preferably the length of at least 1000 genes or segments of genes, even more preferably the length of at least 5000 genes or segments of genes and most preferably the length of at least 20 000 genes or segments of genes.

The value of n is smaller than m. Preferred values for n are from 8 to 100. More preference is given to values from 15 to 60 and most preference is given to those from 20 to 30.

A preferred score type is the number of exactly corresponding nucleotides (=matches) within each region of a given length, for example the length n. This score type uses matches between the two fragments, found in a partial sequence of the length n with the aid of global alignment. Said score type is absolute, i.e. each base match increases the score by one. Thus, a maximum score of n is possible, corresponding to a complete match. Said score can be expressed as follows:

$${Score}_{i} ( n ) = {\sum }_{j = i}^{j = i + n} f ( j )$$

where f(j)=0, if a mismatch is present at the site j, and f(j)=1, if a match is present at the site j, with Scoreᵢ(n) being the score of the partial sequence of the length n with starting point i.

Another preferred score type is the positions of matches and mismatches (noncorresponding nucleotides) in relation to one another. This type is a relative score. A formula for calculating said scores is:

$${Score}_{i} ( n ) = {\sum }_{j = i}^{j = i + n} f ( j ) with f ( j ) = \{ \begin{matrix}{c}_{s} , & j = single match \\ {c}_{b} , & j = starting match \\ {c}_{i} , & j = inner match \\ {c}_{m} , & j = mismatch \\ {c}_{g} , & j = gap \\ {c}_{d} , & j = deletion\end{matrix} ,$$

where cₓ is in each case a constant. Single match refers to a match having no neighboring matches, starting match refers to a match which has exactly one neighboring match and inner match refers to a match having two neighboring matches. In addition, the constant value for a match may moreover be multiplied with a factor which depends on the base forming said match.

Yet another preferred score type is a value for the stability of binding on the segment of the length n.

In a further embodiment, step (a) is carried out separately in time from the other steps and the results are temporarily stored.

In a further embodiment, step (a) of the method of the invention for selecting a partial sequence of the length n from a nucleic acid sequence of the length m comprises generating the list in the form of a database, said database containing data sets comprising in each case a given nucleic acid sequence of the length m, at least one partial sequence of at least a length n and at least one score of at least one type, which pertains to said partial sequence, and said at least one score describing the degree of correspondence of the partial sequences of the length n of the total sequence.

Step (a) of the method of the invention for selecting a partial sequence of the length n from a nucleic acid sequence of the length m comprises the following steps

(a1) aligning the nucleic acid sequence of the length m with the total sequence which does not include said nucleic acid sequence of the length m,

(a2) generating, where appropriate, a specificity string from the results of the alignment,

(a3) calculating the scores for the partial sequence of the length n on the basis of the results of the alignment and/or on the basis of the specificity string,

(a4) storing the scores calculated in step (a3) and

(a5) repeating, where appropriate, the steps (a1) to (a3) with an optionally modified total sequence and merging the scores obtained with the scores stored in step (a4).

In a further embodiment, the steps (a1) to (a5) are carried out instead of the steps (I) to (III) of the above-described method for determining the similarity of a nucleic acid sequence with respect to a given total sequence. In yet another embodiment, no minimum correspondence is defined for the alignment.

The Smith & Waterman algorithm is used for alignment in step (a) of the method for determining the similarity of a nucleic acid sequence with respect to a given total sequence or/and in step (a1) for selecting a partial sequence of the length n from a nucleic acid sequence of the length m of in each case two of the selected fragments in order to ensure as good a global alignment of said two sequences as possible. If the size of the Smith & Waterman matrix to be generated exceeds a predefined size, the alignment problem is divided into part problems using the Divide&Conquer method, until the matrix of the latter no longer exceeds the predefined size. Alternatively, it is possible to use algorithms such as BLAST or/and FASTA or/and Suffix-Trees.

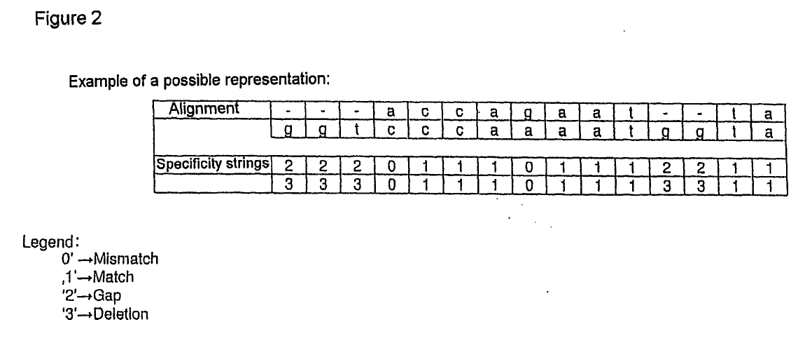

The result of the above-described alignment, representation of the compared sequences with deletions and gaps, is, where appropriate, converted to “specificity strings”. These strings are used for abstraction and represent only the type of the individual sequence elements but not their contents any more (FIG. 2).

It is then possible to evaluate the alignment with the aid of the specificity string for the fragment whose specificity is to be determined. For this purpose, each partial region of said specificity string is contemplated. The size of said partial regions is determined by the desired length of the probes to be determined; it is therefore sensible to assess the specificity string for different probe lengths. Thus, the information obtained at the base level (match/mismatch) is then replaced by information about the specificity of the possible n-mers of this fragment.

The evaluation is carried out by calculating various scores for each region of the specificity string of the length n. Preference is given to calculating the scores in step (a3) for more than one value of n. Calculating the scores for various lengths n makes it possible to separate the calculation of specificity from the selection of oligonucleotides. Thus it is possible later to vary the probe lengths, without having to calculate again the specificities for other probe lengths. The calculation of scores for more than one n thus has the advantage of greater flexibility. Thus the probe length is available as an additional parameter for selecting the best probe, with no substantial increase in the amount of calculation. Calculating scores for a multiplicity of values of n, preferably for predetermined values or for all values from 8 to 100, more preferably for predetermined values or all values from 15 to 60, most preferably for predetermined values or all values from 20 to 30, enables the calculation of specificity to be decoupled from the later (fast) selection of suitable probe sequences, since it is possible to include the specificity data for the appropriate probe length. This is carried out efficiently by determining the specificities for these lengths as scores. The various scores are stored, with a specificity string of the length m having a total of m-n+1 values per length n and score type.

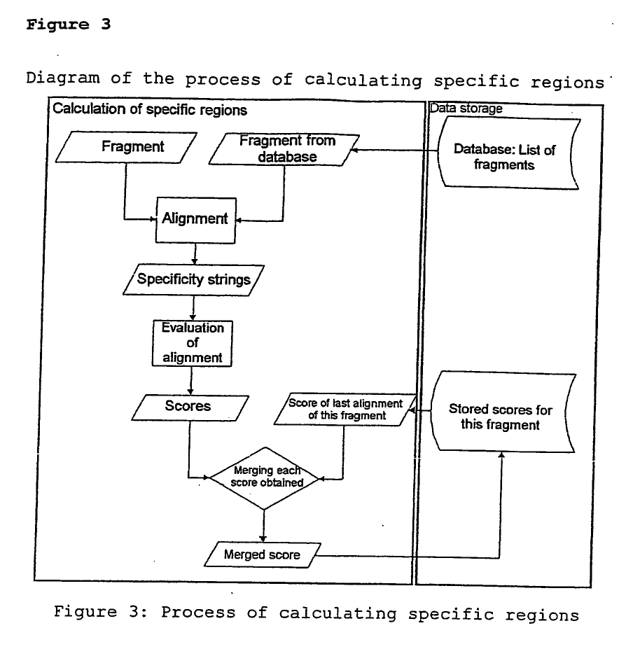

The results of the calculation of specificity can be depicted entirely in a relational database system (FIG. 3). In order to be able to include all alignments of a fragment into the evaluation, the scores of the individual alignments must be merged. This procedure produces for each partial region of the fragment studied one or more values for the specificity of this segment. If a fragment is to be compared to more than one other fragment, it is necessary to merge the scores obtained in the different alignments to give an overall evaluation. In a preferred embodiment, this is carried out by comparing two calculated scores for the same partial sequence of the length n and then, depending on the method, taking either the higher or the lower of these two values as the new score. This is carried out for all segments of the length n and for each fragment with which the starting fragment is compared. The result is the overall evaluation of the fragment with respect to all compared fragments. Said evaluation contains for each partial sequence n, depending on the method chosen, either the lowest value determined in all alignments or the highest value determined in all alignments.

$$Thus \text{:}$$

$${Score}_{n} ( i ) = {max}_{j} ( {Score}_{nj} ( i ) ) or {Score}_{n} ( i ) = {min}_{j} ( {Score}_{nj} ( i ) ) ,$$

where Scoreₙ(i) is the total score for the partial sequence of the length n at position i in the fragment and Scoreₙⱼ(i) is the score of the alignment of the starting fragment with the j-th fragment for the partial sequence of the length n at position i.

In another preferred embodiment, merging is carried out by averaging all partial scores or the sum of all partial scores. It is also possible to use different types of merging in parallel.

In another preferred embodiment, the absolute criterion used in step (c) is the length n of the probes. Preferred values are from 8 to 100 bases, more preferably 15 to 60 bases and most preferably 20 to 30 bases. Another criterion is the number of times the same base appears consecutively in the partial sequence of the length n, preference being given here to fewer than 4 consecutive identical bases. It is furthermore possible to use the percentage of CG (CG content) in the partial sequences as an absolute criterion. For partial sequences of the length n=25, preference is given to a CG content of from 40 to 50%, a particularly preferred value being 48%. Furthermore, preference is given to partial sequences which overlap with other partial sequences only to a certain degree, and particular preference is given to a selected probe corresponding to another selected probe at the 3′ or 5′ end by no more than 5 bases.

The above-described procedure makes it possible to filter redundant information from uncorrected sets of fragments. After aligning two sequences, it is possible to determine with the aid of the specificity string and/or of the score values a value for the correspondence of said sequences over the entire length. If this value exceeds a set threshold, the fragments are regarded as being redundant. It is then possible to exclude said redundant fragment from the calculation.

The process of determining specific regions for a multiplicity of fragments (e.g. all genes of an organism) represents an enormous amount of calculation needed. If each gene in an organism having 10 000 genes is to be tested against all the genes present, then a total of 100 million comparisons according to Smith & Waterman, BLAST or/and FASTA are to be carried out for said organism. The currently available standard PC hardware will need several months for this. However, this process is virtually completely parallelizable. Each of the fragments to be studied can be tested separately against the chosen database, without having to expect dependences on third processes.

It is then possible to establish a central management server which contains the list of fragments to be studied and information on parameters and the database against which each fragment is to be tested. Querying client computers are allocated in each case a fragment to be studied from the list. Said fragment is annotated on said management server as “being processed”. After a client has processed a fragment and the result has been stored, said fragment is deleted from the list of fragments to be studied on the management server. Mechanisms for recognizing faulty client computers and client computers no longer involved in the calculation help preserving consistency here. By connecting, for example, a multiplicity of standard PCs, such a server-client system can be made into a very inexpensive and powerful “virtual mainframe computer”. Therefore, preference is given to using a client-server system for calculating specificity. In particular, step (I) of the method for determining the similarity with respect to a given total sequence or/and step (a) of the method for selecting a partial sequence of the length n from a nucleic acid sequence of the length m is carried out in parallel for at least two different partial sequences on at least two clients, using a client-server system.

The probes selected in the selection of oligonucleotides from a predefined sequence should fulfill a plurality of demands. First, their general parameters such as the desired length or the overlap permitted between the probes must be fulfilled. Secondly, only those oligonucleotides should be selected whose sequence motifs promise similar biochemical properties. Said properties range from the stability of the duplex compounds formed during hybridization to the tendency of the probe to form three-dimensional secondary structures. In addition, the data from the calculation of specificity are also used here for selection.

One problem in the automated selection of oligonucleotides is the fact that the sequence structures from which said oligonucleotides are to be selected cannot be predicted. Some fragments here provide possibly a satisfactory selection of oligonucleotides which fulfill all parameters. Other fragments, however, have a proportion of guanine or cytosine, which is so high or low that it is not possible to attain the required stability of the duplex compounds for any of the probe candidates. Another example would be a fragment which may be found in the database in a largely redundant form and for which it is not possible to select any sufficiently specific oligonucleotides.

A selection logic based on fixed parameters would find here no or not enough probes which fulfill the specifications. This is quite correct, since these were the predefined criteria. An inflexible selection logic, however, would also sort out those oligonucleotides as being unsuitable, which have a melting point which is too high by only 0.1° C., but which have excellent values in all other criteria, i.e. they are highly specific and are located in the desired region of the fragment. The method of the invention thus does not select the oligonucleotides fulfilling all demands but advantageously rather selects the best oligonucleotides from the chosen fragment, taking into account all parameters, even if some criteria are not fulfilled.

Separating the time-consuming determination of specific regions of a fragment from the selection of optimal oligonucleotides makes it possible, after a single time-consuming computation, to modify the oligonucleotide configuration within a very short time, without further time-consuming calculation and without loss of quality of the generated sequences. Said selection of the oligonucleotides proceeds in essential parts by using an evaluation system which always returns the overall best oligonucleotides, without excluding particular parameter values, rather than fixed parameters.

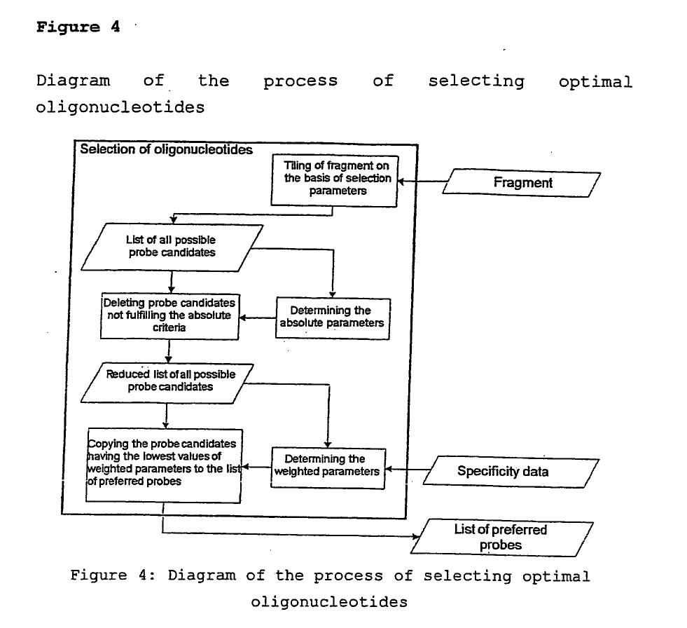

The selection is carried out by implementing weighted parameters (FIG. 4). These parameters have a plurality of properties. First, a preferred value is defined here too (e.g. melting temperature of duplex compounds) and secondly, the user indicates a penalty value which defines a weighting of this parameter compared to the other parameters. A higher value here means a higher penalty value for deviating from the preferred value and thus a lower classification of this probe. The penalty values of all weighted parameters are added up. The probes having the lowest penalty values are thus the best possible probes, taking into account all parameters. This principle is very similar to the “survival of the fittest” known from biology, since here only the probes which have adapted best overall are selected.

Aside from the weighted parameters, rigid parameters (absolute parameters) which define some exclusion criteria (see above) must additionally be used.

The parameters used can be divided into three categories:

1. Selection parameters: these parameters are used for preselection of the probes (e.g. length of probes).

2. Absolute parameters: exceeding or staying below these parameters results in the exclusion of this probe. Examples of these are the above-described parameters of base composition (CG content), overlapping of probes, length of probes or number of times the same base appears consecutively in the partial sequence, which parameters have proved to be essential and not tolerable in the practical experiment.

3. Weighted parameters: exceeding or staying below these values does not result directly in exclusion of the probe. Each of these parameters is allocated a multiplier (weighting).

The oligonucleotides are selected by first generating all possible probes according to the selection parameters. For example, all possible 20 mers are generated from a 2000 bp fragment. Thus, in this example, 1981 probe candidates of 20 base pairs in length are obtained (overlap).

The next step is calculating all values of the absolute parameters. If a probe candidate exceeds or stays below the chosen limits, it is deleted internally from the list of possible candidates.

All weighted parameters are then determined for each candidate of this reduced list of probe candidates. Subsequently, the values obtained of the weighted parameters are added up to give a total score for each candidate. The specificity data calculated for the partial sequences may also be included here as weighted parameters. According to the weightings predefined by the user, the probe candidates having the lowest total score are the optimal probes and are copied from the list of probe candidates to the list of selected probes, taking into account the permitted overlap and the number of probes.

Thus, the invention further relates to a method for selecting nucleic acid sequences from a list of nucleic acid sequences on the basis of a total score for each sequence, which score is calculated from a set of numerical parameters for each sequence, which method comprises the steps

(1) determining preferred values for each parameter and weighting values for each parameter and

(2) linking each parameter to its preferred value and weighting the result to give a penalty value separately for each sequence and

(3) linking the results of step (2) to a total score separately for each sequence and

(4) repeating, where appropriate, steps (1) to (3) one or more times and

(5) selecting on the basis of said total scores those sequences whose parameters deviate the least from the preferred values.

This method may comprise further steps.

In a further embodiment, the method is limited to steps (1) to (5).

In preferred embodiments, the numerical parameters used are the melting temperature of the duplex compound, the position of the probe in the fragment (proximity to the 3′ end), the specificity of the probe or/and the tendency of forming a secondary structure. It is furthermore preferred that the linking as defined in steps (b) and (c) is carried out according to the formula

$$S = {\sum }_{i} {g}_{i} {\vert ( {p}_{i} - {b}_{i} ) \vert}^{q}$$

where S is the total score, pᵢ is a numerical parameter, bᵢ is a preferred value, gᵢ is a weighting factor and q is a number >0. Particular preference is given to O<q<3. More preference is given to 0.5<q<2.5. Most preference is given to q=1 or q=2. The number i is the sequential index for the various parameters.

In further preferred embodiments, the total score is determined according to

$$S = {max}_{i} \vert {g}_{i} ( {p}_{i} - {b}_{i} ) \vert or$$

$$S = {min}_{i} \vert {g}_{i} ( {p}_{i} - {b}_{i} ) \vert$$

The methods of the invention may be employed advantageously, wherever relatively large amounts of genetic information available in databases need to be processed for rapid selection of hybridization probes.

A flexible, rapid and fully automated method for generating DNA arrays with integrated detection in a logical system, as described, for example, in WO 00/13018 and DE 199 40 749.5, makes it possible to obtain, by analyzing the data of one array, the information necessary for constructing a new array within a short time (cycle of information). This cycle of information allows automatic adaptation to the next analysis by selecting suitable polymer probes, for example nucleic acid probes for hybridization for the new array. In this connection, it is possible, taking into account the result obtained, to limit the range of queries in favor of higher specificity or to modulate the direction of the query.

The invention therefore further relates to a programmed device for carrying out the methods of the invention for determining specifically binding oligonucleotides in a relatively large total sequence in preparation of an application of oligonucleotides in a binding experiment in two steps, with a first step for determining regions within said total sequence, which are as specific as possible or rare, and a second step for selecting oligonucleotides in said regions of the processed total sequence.

Therefore, the invention still further relates to the use of a programmed further device in combination with further technical devices for synthesizing the selected oligonucleotide probes. This synthesis is carried out either directly in the form of a reaction support which has a microarray downstream or by means of chemical oligonucleotide synthesis on a column and subsequently applying the oligonucleotide probes on a reaction support.

The total sequence for carrying out a hybridization experiment is, for example, a genome or a transcriptome or parts thereof or sequences of nucleic acids present in samples which can be obtained from one or more organisms. The determination in the first step comprises selection of rarely or uniquely occurring sequence sections in the total sequence and the second step comprises the selection of suitable oligonucleotide probes.

The invention thus also relates to a method for preparing hybridization probes, which comprises

(a) selecting the probes as partial sequence from a nucleic acid sequence with respect to a total sequence by the above-described method, and

(b) synthesizing said probes.

The probes may be applied to one or more reaction supports or synthesized on one or more reaction supports. Preference is given here to applying the hybridization probes to a single reaction support or/and synthesizing said hybridization probes on a single reaction support. The reaction support may be a commercial DNA array. Preference is given to applying simultaneously at least 6000, particularly preferably at least 48 000, hybridization probes.

A particularly preferred reaction support is a microfluidic support. Microfluidic reaction supports of this kind are described in WO 01/08799, for example. Such a reaction support allows a multiplicity of reaction areas to be provided very rapidly, efficiently and thus cost-effectively, for example for integrated synthesis of a multiplicity of hybridization probes and analysis of a multiplicity of nucleic acid fragments by means of said probes.

Another aspect of the invention is a method for determining nucleic acids in a sample, which comprises the steps:

(a) preparing hybridization probes on at least one reaction support, for example on a DNA array, or at least one microfluidic reaction support by the above-described method using a multiplicity of hybridization probes immobilized to particular regions, said hybridization probes having in each case a different specificity in the individual regions, and

(b) contacting the sample containing nucleic acids to be determined with the at least one support under conditions in which a hybridization on said at least one support can take place, and

(c) identifying the predetermined regions on the at least one support, on which a hybridization in step (b) has taken place, and

(d) repeating the steps (a) to (c) one or more times, using in each case reaction supports which contain hybridization, probes which, depending on the result, are modified with respect to the preceding procedure(s) of steps (a) to (c).

The predetermined areas on the at least one support, on which a hybridization has taken place, can be identified by known methods. To this end, the hybridization probes or/and the nucleic acids to be determined may contain a label with a fluorescent dye, for example. The signals may be recorded from all areas simultaneously, for example by using a detection unit comprising an illumination unit and a CCD chip, which sandwich the support.

In step (d), steps (a) to (c) are repeated using modified hybridization probes. Thus, at least one new reaction support having a multiplicity of hybridization probes immobilized to particular areas is provided, said probes being tested according to the method of the invention for their specificity compared to the total sequence and then selected.

The invention is furthermore illustrated by the following figures:

FIG. 1 indicates possible ways for determining optimal oligonucleotides.

FIG. 2 depicts the example of a possible representation of a specificity string.

FIG. 3 depicts the calculation process for specific regions.

FIG. 4 depicts diagrammatically the process of selecting optimal oligonucleotides.

1. A method for determining the similarity of a nucleic acid sequence with respect to a given total sequence, which method comprises the steps
(I) aligning said nucleic acid sequence with said total sequence, determining those contiguous parts of the total sequence, which correspond to a predetermined minimum degree to said sequence or to a partial sequence thereof, and
(II) describing said correspondence of said parts of the total sequence, determined in step (I), to said nucleic acid sequence or to a partial sequence thereof in the form of scores of at least one type for segments of at least a given length and
(III) where appropriate, merging the scores obtained in step (II).

2. A method for selecting nucleic acid sequences from a list of nucleic acid sequences on the basis of a total score for each sequence, which score is calculated from a set of numeric parameters for each sequence, which method comprises the steps
(1) determining preferred values for each parameter and weighting values for each parameter and
(2) linking each parameter to its preferred value and weighting the result to give a penalty value separately for each sequence and
(3) linking the results of step (2) to a total score separately for each sequence and
(4) repeating, where appropriate, steps (1) to (3) one or more times and
(5) selecting on the basis of said total scores those sequences whose parameters deviate the least from the preferred values.

3. The method as claimed in claim 2, in which the numerical parameters used is the melting temperature of the duplex compound, the position of the probe in the fragment (proximity to the 3′ end), the specificity of the probe or/and the tendency of forming a secondary structure.

4. The method as claimed in claim 2, in which the linking as defined in steps (1) and (2) is carried out according to the formula
$$S = {\sum }_{i} {g}_{i} {\vert ( {p}_{i} - {b}_{i} ) \vert}^{q}$$
where
S is the total score,
pᵢ is a numerical parameter,
bᵢ is a preferred value,
gᵢ is a weighting factor,
q is a number >0 and
i is the sequential index for the various parameters.

5. A method for selecting a partial sequence of the length n from a nucleic acid sequence of the length m, whose similarity to a given total sequence which does not include said nucleic acid sequence of the length m should be as low as possible, said method comprising the steps
(a) generating a list of predetermined m-n+1 partial sequences, with scores being calculated for each partial sequence, for example by the method as claimed in claim 1, with respect to the total sequence, and
(b) selecting on the basis of said scores from said list according to step (a) those partial sequences whose similarity to the total sequence which does not include the nucleic acid sequence of the length m is as low as possible, and
(c) excluding those partial sequences of step (b) which do not fulfill predetermined absolute criteria, and
(d) carrying out the method as claimed in any of claims 2 to 4 with the partial sequences remaining after step (c).

6. The method as claimed in claim 5, in which the total sequence is the entire sequence of a genome, for example of a mammal or of human origin, a segment of a genome, for example the transcriptome, a gene library, for example a mixture of clones, a functional group of genes or/and a mixture of various genomes or/and of parts of various genomes or/and of genome sections.

7. The method as claimed in claim 5, in which the score calculated is the number of exactly matching nucleotides or/and the position of said exactly matching and of the nonmatching nucleotides in relation to one another or/and a value for the stability of binding on the segment of the length n.

8. The method as claimed in claim 5, in which carrying out step (a) is separated in time from the other steps and the results are temporarily stored.

9. The method as claimed in claim 5, in which step (a) is carried out using a server-client system in parallel for at least two different partial sequences on at least two clients.

10. The method as claimed in claim 5, in which step (a) comprises generating the list in the form of a database, said database containing data sets comprising in each case a given nucleic acid sequence of the length m, at least one partial sequence of at least a length n and at least one score of at least one type, which pertains to said partial sequence, and said at least one score describing the degree of correspondence of the partial sequences of the length n of the total sequence.

11. The method as claimed in claim 5, in which step (a) comprises
(a1) aligning the nucleic acid sequence of the length m with the total sequence which does not include said nucleic acid sequence of the length m,
(a2) generating, where appropriate, a specificity string from the results of the alignment,
(a3) calculating the scores for the partial sequence of the length n on the basis of the results of the alignment and/or on the basis of the specificity string,
(a4) storing the scores calculated in step (a3) and (a5) repeating, where appropriate, the steps (a1) to (a3) with an optionally modified total sequence and merging the scores obtained with the scores stored in step (a4).

12. The method as claimed in claim 11, in which algorithms according to Smith & Waterman or/and according to BLAST or/and according to FASTA are used for the alignment as defined in step (a1).

13. The method as claimed in claim 11, in which step (a3) comprises calculating the scores for more than one value of n.

14. The method as claimed in claim 11, in which merging as defined in step (a5) is carried out by comparing the scores to one another separately for each type and taking in each case the value showing lower or higher correspondence.

15. The method as claimed in claim 5, in which the absolute criterion used in step (c) is the length n of the probes, the number of times the same base appears consecutively in the partial sequence of the length n, the CG content in the partial sequences or/and the overlap with one or more partial sequences.

16. The method as claimed in claim 15, in which the CG content is from 40 to 50%, in particular 48%, for a length n=25.

17. A method for preparing hybridization probes, which comprises
(a) selecting the probes as partial sequence from a nucleic acid sequence with respect to a total sequence by the method as claimed in claim 5, and
(b) synthesizing said probes.

18. The method as claimed in claim 17, in which the hybridization probes are applied to or/and synthesized on a single reaction support.

19. The method as claimed in claim 18, in which the reaction support is a microfluidic support.

20. A method for determining nucleic acids in a sample, which comprises the steps:
(a) preparing hybridization probes on at least one reaction support by the method as claimed in claim 17 using a multiplicity of hybridization probes immobilized to particular regions, said hybridization probes having in each case a different specificity in the individual regions, and
(b) contacting the sample containing nucleic acids to be determined with the at least one support under conditions in which a hybridization on said at least one support can take place, and
(c) identifying the predetermined regions on the at least one support, on which a hybridization in step (b) has taken place, and
(d) repeating the steps (a) to (c) one or more times, using in each case reaction supports which contain hybridization probes which, depending on the result, are modified with respect to the preceding procedure(s) of steps (a) to (c).


SEQUENCE LISTING (2 sequences)

SEQ ID NO: 1 - DNA, 10 bp, Artificial sequence
  oligonucleotide sequence that may be derived from any prokaryotic or eukaryotic organism
accagaatta

SEQ ID NO: 2 - DNA, 15 bp, Artificial sequence
  oligonucleotide sequence that may be derived from any prokaryotic or eukaryotic organism
ggtcccaaaatggta